(19) United States
(12) Patent Application Publication
(10) Pub. No.: US 2011/0289282 A1
(43) Pub. Date: Nov. 24, 2011

(54) Sessions for Direct Attached Storage Devices

(75) Inventors: Nathan Steven Obr, Seattle, WA (US); Vladimir Sadovsky, Redmond, WA (US)

(73) Assignee: Microsoft Corporation, Redmond, WA (US)

(21) Appl. No.: 12/833,140

(22) Filed: Jul. 9, 2010

Related U.S. Application Data
(60) Provisional application No. 61/345,912, filed on May 18, 2010.

(51) Int. Cl. G06F 12/00

(52) U.S. Cl. 711/154; 711/E12.001

(57) ABSTRACT

A mechanism and a storage device are provided for registering a component of a computing device, with a user-removably attached storage device and managing sessions between the component and the storage device. The storage device may record time information regarding a beginning and an ending of an activity session with the component. The storage device may determine whether at least a logical block address range of a storage device medium, registered by the component, may have been modified by a different component, since a last session with the component. When the storage device indicates to the component that at least the logical block address range of the medium has not been modified since the last session, the component may trust contents of the medium. The computing device may provide time information to the storage device, such that the storage device may determine whether management operations are to be performed.

This application claims the benefit of U.S. Provisional Patent Application No. 61/345,912 filed in the United States Patent and Trademark Office on May 18, 2010.

### BACKGROUND

An underdeveloped aspect of client direct attached storage protocols is any recording and communicating of discovered external real world events. Client configurations and usage for direct attached storage devices, such as serial advanced technology attachment (SATA) devices, IEEE 1394 devices, and universal serial bus (USB) devices, including, but not limited to, hard disk drives (HDDs) and solid state drives (SSDs), include frequent power cycles, separations, and roaming.

Although a device can have a clock and can keep track of a passage of time relative to when its power cycle began, currently, there is no mechanism for a host and a device to synchronize on a current time. Many storage devices, including HDDs and SSDs perform regular media maintenance based on a passage of a specific amount of time. Although a device may sit unpowered for a minute or a year between power cycles, the device cannot determine how much time passed while it was electrically off.

A scenario that is of interest to a host is discovering a separation of two devices that make up a separated cache solution, which depends on a repeated connection of directly attached storage devices to the host. A device partitioned to contain cached data from a target storage device may become invalid if the target storage device is used without the cache device, or if the cache device is used on a different host before being returned to a host implementing the separated cache solution.

A host may further benefit from discovering an intermittent device failure. A host whose primary storage device suffers an intermittent failure cannot record failure information due to the storage device being non-operational. The host may benefit from discovering failure information from the storage device after a reset. For example, the failure information from the storage device may lead the host to determine that a previous session between the host and the storage device ended prematurely due to an intermittent device failure.

Currently, no mechanisms exist to programmatically associate, share and synchronize events, or manage operational power sessions between a host and device.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In one aspect of various embodiments, a mechanism is provided for a host to establish a beginning and an end of a host component's activity session with a user-removable storage device. The storage device may be directed by the host to store time information regarding a starting time and an ending time of an activity session with the host. The storage device may determine how much time has passed between power sessions by comparing the stored time information with previously-stored time information. As a result, the storage device may perform actions including, but not limited to, recognizing when background management operations should be performed, determining when the storage device is powered on without being associated with any host and performing the background management operations when the storage device is powered on without being associated with any host.

In another aspect of various embodiments, a storage device is able to record history about its associations with hosts and usage of the storage device by the hosts. As a result, scenarios which are dependent upon being able to identify unbroken spans of association, even across power cycles, become detectable. This allows a host to make optimizations including, but not limited to, continuing trust of data stored on a medium of a storage device being used as a cache even after a host power cycle, or identifying when an unexpected loss of a device or a host crash has occurred.

### DRAWINGS

In order to describe the manner in which the above-recited and other advantages and features can be obtained, a more particular description is discussed below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a functional block diagram illustrating an exemplary operating environment for various embodiments.

FIG. 2 is a functional block diagram illustrating an exemplary embodiment of a user-removable storage device.

FIG. 3 illustrates a number of computing device components having mutually exclusive active sessions with a user-removably attached storage device.

FIG. 4 is a flowchart of an exemplary process that may be performed by a computing device and a user-removably attached storage device to generate and register a component identifier.

FIG. 5 is a flowchart of an exemplary process for registering a component identifier with a user-removably attached storage device.

FIG. 6 is a flowchart of an exemplary process for registering one or more logical block address (LBA) ranges with a user-removably attached storage device.

FIG. 7 is a flowchart illustrating exemplary processing with respect to a user-removably attached storage device receiving a begin session command from a connected computing device.

FIG. 8 illustrates various computing device components of a computing device beginning and ending sessions with a user-removably attached storage device.

FIG. 9 is a flowchart illustrating an exemplary procedure that may be performed with respect to processing a query regarding modifications to a medium of a user-removably attached storage device.

FIG. 10 illustrates exemplary layering with respect to a driver stack within a computing device.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Overview

In various embodiments, a storage device that is user-removably attached to a computing device (a host) may record information regarding a time when a computing device component's activity session with the user-removably attached storage device has begun and ended. A component may represent a host operating system component (e.g. a driver stack) as well as a preboot environment component (e.g. an extensible firmware interface (EFI) module). A command may be sent from the computing device to the user-removably attached storage device to register or unregister a computing device component with the user-removably attached storage device. The command may include a timestamp and an argument that specifies a register command or an unregister command. The user-removably attached storage device may record a beginning session timestamp and an ending session timestamp. The user-removably attached storage device may be capable of identifying a computing device (host) component in control of the user-removably attached storage device, may be capable of identifying which I/Os are coming from the identified computing device component as opposed to some other computing device component, and may be capable of identifying which logical block addresses (LBAs) of a medium of the user-removably attached storage device are associated with the computing device component so that only modifications to sensitive areas are taken into consideration.

A register command and an unregister command may include an identifier to be registered or unregistered, respectively, with the user-removably attached storage device. The identifier may be associated with a computing device component. Within a scope of all identifiers registered with a particular user-removably attached storage device, each registered identifier may be different from all other registered identifiers. In some embodiments, identifiers may be generated by components of a computing device at run time. In other embodiments, identifiers may be encoded into a non volatile memory of a computing system.

When creating an identifier to be associated with a particular computing device component, the computing device may query the user-removably attached storage device for identifiers registered with the user-removably attached storage device and may create an identifier which is different from the registered identifiers. The user-removably attached storage device may identify modifications to a medium of the user-removably attached storage device that occur between a time at which a beginning of a session is recorded and a time at which an ending of the session is recorded. The user-removably attached storage device may identify a modification as originating from a particular computing device component.

A registration mechanism is provided for establishing one or more ranges of LBAs as being associated with a specific computing device component, such as, for example, a software component or other component, and a command may be used by a computing device component to query the user-removably attached storage device for an occurrence of any modifications to registered LBA ranges from any other computing device component of a same computing device or a different computing device. The query command may have arguments including an identifier associated with the computing device component, and an LBA range(s) being queried. The query command may return a status of clean (no other computing device component modified the given LBA range(s)) or dirty (at least one other computing device component modified the given LBA range(s) or a component of another computing or virtual computing device modified the given LBA range).

As a result of recording a beginning and an ending of a session, the user-removably attached storage device may provide a notification to the computing device component regarding a previous activity session not having a proper session ending due to, for example, a reset command or a power break occurring before a session ending. The user-removably attached storage device may provide the notification in response to the register command or a separate query command.

Computing device (host) sessions with a user-removably attached storage device may include multiple mutually exclusive active computing device components, such as, for example Basic Input Output System (BIOS), Normal session driver, post operation driver (hibernate, crashdump), or other computing device component. Each computing device component may use the device exclusively when active. Consequently each computing device component may have its own activity session with the user-removably attached storage device. A session with a user-removably attached storage device may include all time from power on to power off of the user-removably attached storage device.

### Exemplary Computing Device

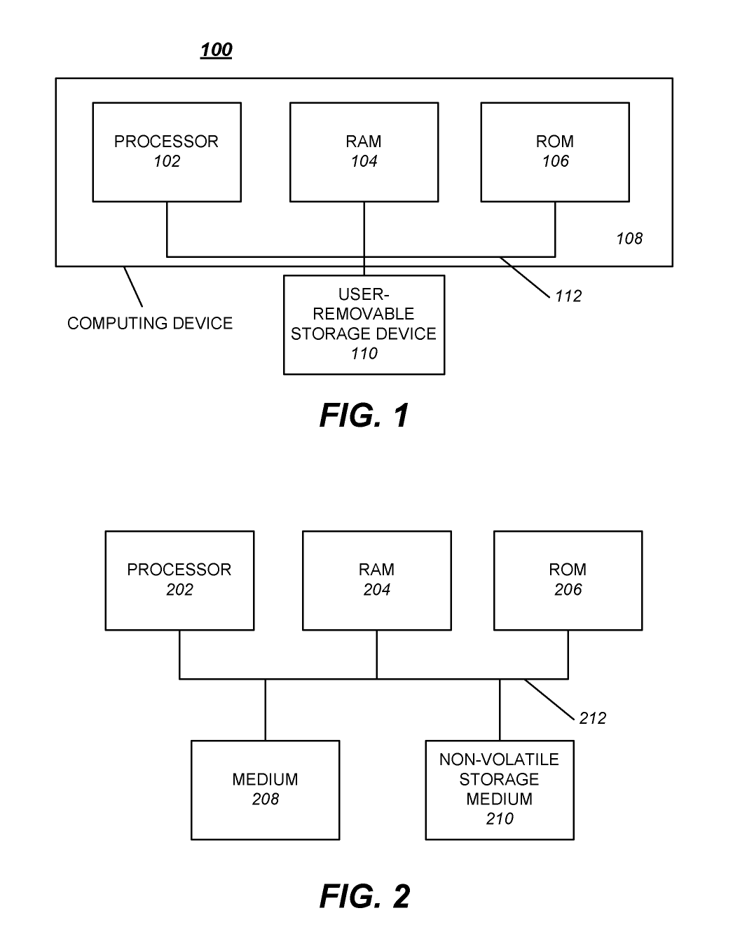

FIG. 1 is a functional block diagram of an exemplary operating environment 100 for various embodiments. Exemplary operating environment 100 may include a computing device 108, which may function as a host, and a user-removable storage device 110.

Computing device 108 may include a processor 102, a random access memory (RAM) 104, a read only memory (ROM), and a communication bus 112 connecting processor 102, RAM 104 and ROM 106.

Processor 102 may include one or more conventional processors that interpret and execute instructions. A memory may include RAM 104, ROM 106, and/or another type of dynamic or static storage device that stores information and instructions for execution by processor 102. RAM 104, or another type of dynamic storage device, may store instructions as well as temporary variables or other intermediate information used during execution of instructions by processor 102. ROM 106, or another type of static storage device, may store static information and instructions for processor 102.

Computing device 102 may perform functions in response to processor 102 executing sequences of instructions contained in a non-transitory machine-readable medium, such as, for example, RAM 104, ROM 106, or other non-transitory medium. Such instructions may be read into RAM 106 from another non-transitory machine-readable medium or from a separate device via a communication interface (not shown).

User-removable storage device 110 may be user-removably attached to computing device 108, such that processor 102 and user-removable storage device 110 may communicate with each other via communication bus 112.

### Exemplary User-Removable Storage Device

FIG. 2 is a functional block diagram of an exemplary user-removable storage device 110. User-removable storage device 110 may include a processor 202, a RAM 204, a ROM 206, a medium 208, a non-volatile storage medium 210, and a communication bus 212 connecting processor 202, RAM 204, ROM 206, medium 208 and non-volatile storage medium 210.

Processor 202 may include one or more conventional processors that interpret and execute instructions. A memory may include RAM 204, ROM 206, and/or another type of dynamic or static storage device that stores information and instructions for execution by processor 202. RAM 204, or another type of dynamic storage device, may store instructions as well as temporary variables or other intermediate information used during execution of instructions by processor 202. ROM 206, or another type of static storage device, may store static information and instructions for processor 202.

Medium 208 may include flash RAM, magnetic disk, optical disk or other medium for storing data and/or instructions. Non-volatile storage medium 210 may include a non-volatile medium capable of retaining stored information through power cycles. In some embodiments, medium 208 may include non-volatile storage medium 210.

### EXEMPLARY EMBODIMENTS

### Registration

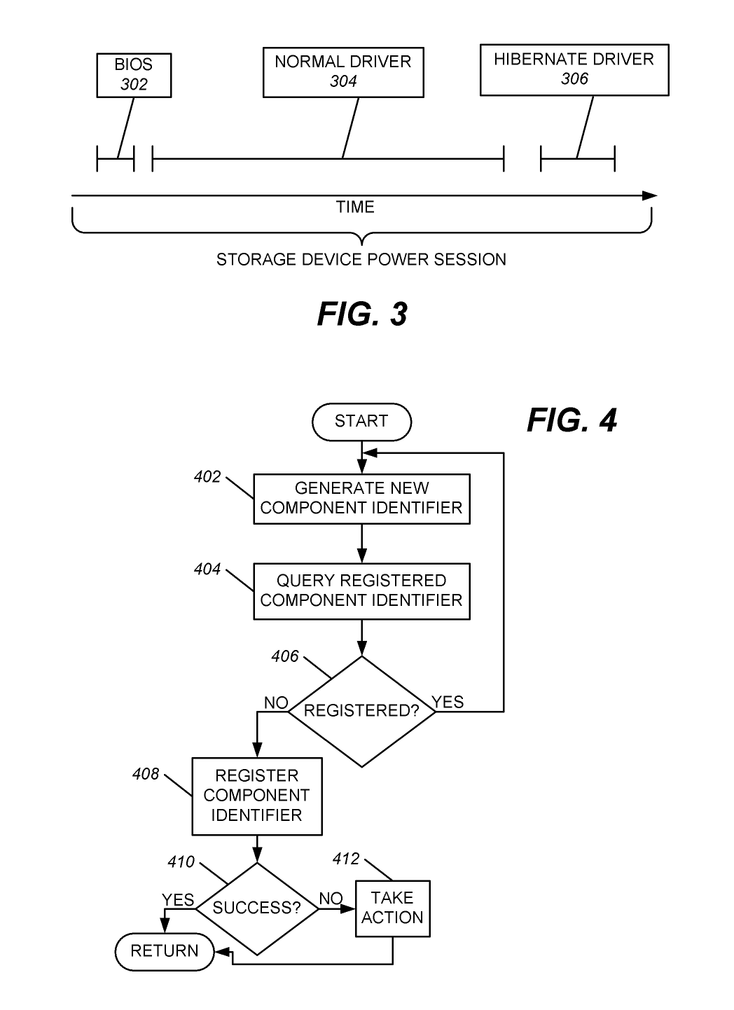

FIG. 3 illustrates multiple computing device components having a mutually exclusive active session with a user-removably attached storage device. The multiple computing device components in FIG. 3 include a Basic Input/Output System (BIOS) 302, a normal session device driver 304, and a hibernate driver 306. Each of the sessions with the user-removably attached storage device may have a session ID, by which each of the multiple computing device components and the user-removably attached storage device may identify a specific session.

FIG. 4 is a flowchart of an exemplary process that may be performed by a computing device and a user-removably attached storage device when a computing device component attempts to generate and register a new component identifier with the removably-attached storage device. The process may begin with the computing device component generating a component identifier which is to be associated with the computing device component (act 402). Alternatively, the component identifier may have been previously stored. In one embodiment, the component identifier may be generated randomly. The computing device component may then send a query command to the user-removably attached storage device (act 404). The query command may include the component identifier.

The user-removably attached storage device may then receive the query command and may determine whether the component identifier, included in the query command, is already registered with the user-removably attached storage device (act 406). If the user-removably attached storage device determines that the component identifier is already registered, then the user-removably attached storage device returns an indication to the computing device indicating that the component identifier is already registered and the computing device component may then repeat acts 402-406 to generate a new component identifier and to determine whether the new component identifier is registered with the user-removably attached storage device.

If the user-removably attached storage device determines, act 406, that the component identifier is not registered with the user-removably attached storage device, then the computing device may send a register command to the user-removably attached storage device (act 408). The register command may include the component identifier and a registration identifier. In some embodiments, the registration identifier may include time information, such as, for example a timestamp corresponding to a time of the computing device, including, but not limited to, a current time according to the computing device. In other embodiments, the registration identifier may include a randomly generated number.

The user-removably attached storage device may receive the register command and may register the component identifier and the registration identifier and may return an indication of success or failure to the computing device (act 408). The computing device may then determine whether the indication returned (or sent from the user-removably attached storage device) is a success indication. If the returned indication is a success indication, then the process is completed. Otherwise, the computing device may take, or perform, an action based upon a particular value of the indication of failure (act 412). In one implementation, the taken action may include repeating acts 408 and 410 again until either the returned indication is a success indication or acts 408 and 410 have been repeated a given number of times. In another implementation, the taken action may include providing the indication of the failure to a calling procedure and returning to the calling procedure.

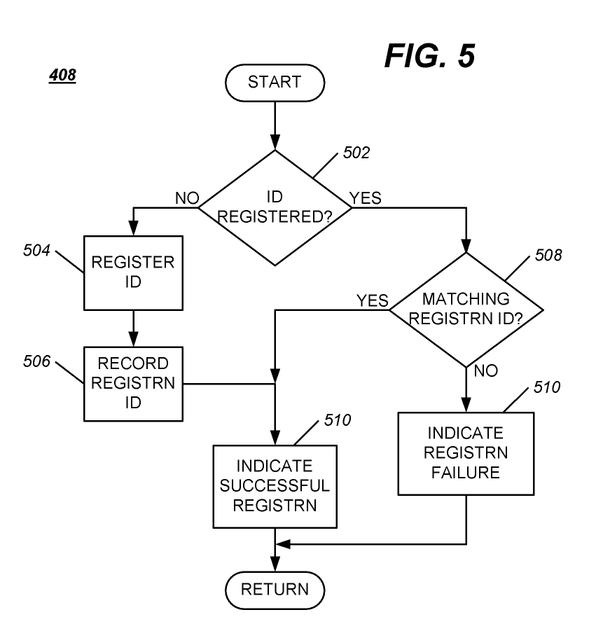

FIG. 5 is a flowchart illustrating an exemplary process performed during act 408 (FIG. 4) in various embodiments. The process may begin with the user-removably attached storage device determining whether the component identifier included in the register command is registered with the user-removably attached storage device (act 502). The user-removably attached storage device may make the determination by checking a medium or a non-volatile medium of the user-removably attached storage device.

If the component identifier is determined not to be registered with the user-removably attached storage device, then the user-removably attached storage device may record the component identifier (act 504) and the registration identifier (act 506) in the medium or the non-volatile medium. The user-removably attached storage device may then send a response to the computing device indicating a successful registration (act 512) and the process may be completed.

If, during act 502, the user-removably attached storage device determines that the component identifier included in the register command is already registered with the user-removably attached storage device, then the user-removably attached storage device may reference a recorded registration identifier associated with the registered component identifier and may determine whether the recorded registration identifier matches a registration identifier included in the received register command (act 508).

If the recorded registration identifier matches the registration identifier included in the received register command, then the user-removably attached storage device may send a successful registration indication to the computing device (act 512) and the process may be completed.

If, during act 508, the user-removably attached storage device determines that the recorded registration identifier does not match the registration identifier included in the received register command, then the user-removably attached storage device may send a registration failure indication to the computing device (act 512) and the process may be completed.

In some embodiments, one or more logical block address (LBA) ranges of a medium of a user-removably attached storage device may be registered with respect to a component identifier. Multiple registered component identifiers may be registered with corresponding overlapping LBA ranges. A register LBA range command may include a component identifier, a registration identifier, and a creator signature. The creator signature may denote a nature of the one or more LBA ranges, such as, for example, new technology file system (NTFS), Microsoft (MSFT) flash cache, Intel flash cache format 1, Intel flash cache format A, etc.

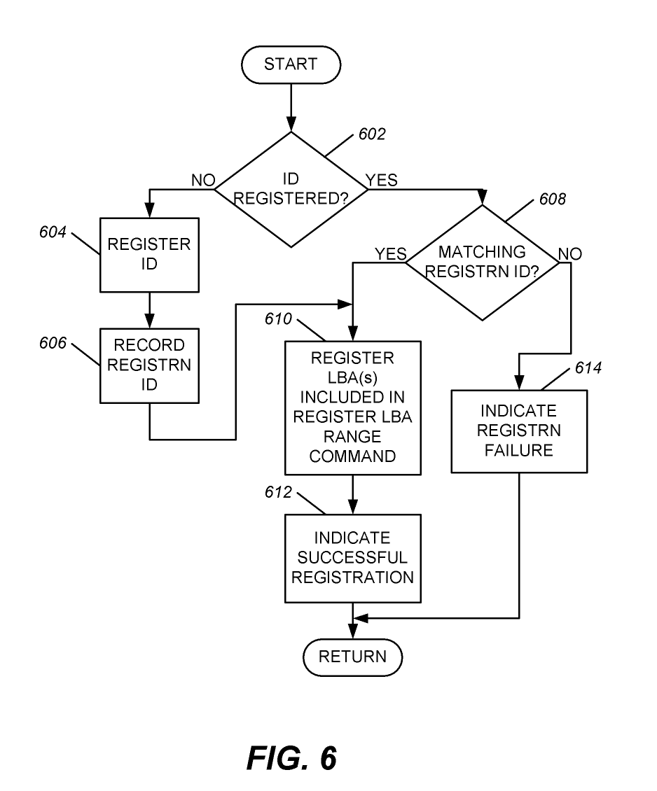

FIG. 6 is a flowchart of an exemplary process for registering one or more LBA ranges in an embodiment. The process may begin with a user-removably attached storage device determining whether a component identifier, included in a register LBA command received from a computing device, is already registered with the user-removably attached storage device (act 602). In some embodiments, a command to register one or more LBA ranges may be received by the user-removably attached storage device after receiving a command to register a computing device component with the user-removably attached storage device.

If the component identifier is not already registered, then the user-removably attached storage device may register the component identifier by recording the component identifier in a medium of the user-removably attached storage device (act 604). In some embodiments, the medium may be a non-volatile medium. The user-removably attached storage device may then record a registration identifier, included in the register LBA command, in the medium of the user-removably attached storage device (act 606). Next, the user-removably attached storage device may then register the one or more LBA ranges, included in the register LBA range command, by recording the one or more LBA ranges in the medium of the user-removably attached storage device (act 610). The user-removably attached storage device may then send an indication to the computing device indicating a successful registration (act 612). The process may then be completed.

If, during act 602, the user-removably attached storage device determines that the component identifier is registered, then the user-removably attached storage device may determine whether a registration identifier included in the register LBA command matches a registration identifier associated with the registered component identifier recorded in the user-removably attached storage device (act 608). If the registration identifier included in the register LBA command matches the registration identifier associated with a registered component identifier recorded in the user-removably attached storage device, then act 610 and 612 may be performed, as previously described. The process may then be completed.

If, during act 608, the user-removably attached storage device determines that the registration identifier included in the register LBA command does not match the registration identifier associated with the registered component identifier recorded in the user-removably attached storage device, then the user-removably attached storage device may send an indication to the computing device indicating a registration failure (act 614). The process may then be completed.

A computing device component may query a user-removably attached storage device regarding registered LBA ranges by sending a query registered LBA ranges command to the user-removably attached storage device. Upon receiving the query registered LBA ranges command, the user-removably attached storage device may determine whether any of the LBA ranges are registered, and if so, may return, to the computing device, information regarding all registered LBA ranges with respect to the user-removably attached storage device and corresponding creator signatures used during registration. In some embodiments, if an LBA range is registered multiple times, then the LBA range would be included in a query response, from the user-removably attached storage device, the multiple times, along with the corresponding creator signatures used during each registration.

### Session Management

A begin session command may be sent from a computing device component to a user-removably attached storage device to start a session therebetween before any I/O occurs between the computing device component and the user-removably attached storage device. After a last I/O between the computing device component and the user-removably attached storage device, an end session command may be sent from the computing device component to the user-removably attached storage device to end the session between the computing device component and the user-removably attached storage device is ended.

A begin session command and an end session command may include a host component identifier, a session identifier, and a timestamp. The timestamp may include time information from the computing device. In some embodiments, the session identifier may include time information from the computing device. In response to receiving a begin session command or an end session command, the user-removably attached storage device may return an indication of success or failure to the computing device.

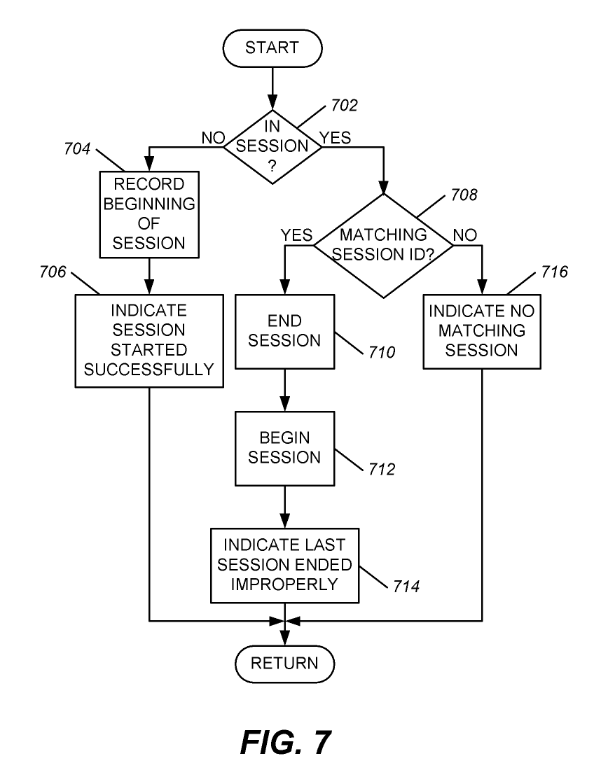

FIG. 7 is a flowchart illustrating exemplary processing which may be performed by a user-removably attached storage device after receiving a begin session command from a connected computing device. The process may begin with the user-removably attached storage device determining whether a component of the computing device, corresponding to a component identifier included in the begin session command, is already in a session (act 702). If the component is not in a session, then the user-removably attached storage device may record a beginning of the session, a session identifier and time information regarding a beginning time of the session in a medium of the user-removably attached storage device (act 704). The user-removably attached storage device may then send an indication to the computing device to indicate that the session started successfully (act 706). The process may then be completed.

If, during act 702, the user-removably attached storage device determines that the component is in a session, then the user-removably attached storage device may determine whether a session identifier included in the begin session command matches a recorded session identifier of the session (act 708). If the session identifiers match, then the user-removably attached storage device may record, in the medium, an end of the session and time information regarding the ending time of the session in the medium of the user-removably attached storage device (act 710). The user-removably attached storage device then may record, in the medium, a beginning of the session and time information regarding the beginning of the session in the medium of the user-removably attached storage device (act 712). The user-removably attached storage device may send an indication to the computing device to indicate that a last session ended improperly (act 714). The process may then be completed.

If, during act 708, the user-removably attached storage device determines that the session identifier included in the begin session command and the recorded session identifier do not match, then the user-removably attached storage device may send a failure indication to the computing device to indicate that the session identifier in the begin session command does not match the recorded session identifier (act 716). In some embodiments, after receiving the failure indication, the computing device may provide a failure indication to a user or may override a setting of the session identifier. The process may then be completed.

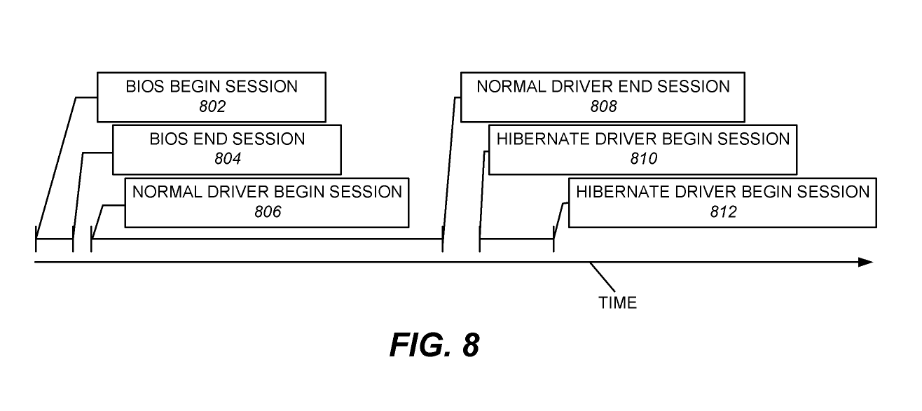

FIG. 8 illustrates a beginning and an ending of a number of sessions between various computing device components and a user-removably attached storage device. Before initiating any I/O with the user-removably attached storage device, a BIOS component of a computing device may send a begin session command 802 to the user-removably attached storage device. I/O may then occur between the BIOS component and the user-removably attached storage device. After all I/O activity has completed between the BIOS component and the user-removably attached storage device, the BIOS component may send an end session command 804 to the user-removably attached storage device to end the session.

At a later point in time, a normal driver component of the computing device may send a begin session command 806 to the user-removably attached storage device before any I/O activity occurs therebetween. After all I/O activity has completed between the normal driver component and the user-removably attached storage device, the normal driver component may send an end session command 808 to the user-removably attached storage device and the session.

Sometime later, a hibernate driver component of the computing device may send a begin session command 810 to the user-removably attached storage device before initiating any I/O therebetween. I/O may then occur between the hibernate driver component and the user-removably attached storage device. After all I/O activity has completed between the hibernate driver component and the user-removably attached storage device, the hibernate driver component may send an end session command 812 to the user-removably attached storage device to end the session.

As can be seen in FIG. 8, a begin session command and an end session command normally surround I/O activity between a computing device component and a user-removably attached storage device. As a result, an abnormal session termination may be detected by the user-removably attached storage device. For example, if a beginning of a previous session has no corresponding ending of the previous session, then the previous session terminated abnormally. As a specific example, suppose a normal driver component sends a first begin session command to a user-removably attached storage device. At a later point in time, the normal driver component may send a second begin session command to the user-removably attached storage device without having sent an intervening end session command. The user-removably attached storage device may determine that an abnormal session termination occurred when two begin session commands were received with no intervening end session command.

In some embodiments, a computing device component may send a query abnormal session termination command to a user-removably attached storage device. The user-removably attached storage device may receive the query abnormal session termination command and may determine whether two begin session commands had been received with no intervening end session command. If two begin session commands were received with no intervening end session command, then the user-removably attached storage device may send an abnormal session termination indication to the computing device component along with a component identifier associated with the abnormal session termination. If the user-removably attached storage device determines an absence of an occurrence of two begin session commands with no intervening end session command, then the user-removably attached storage device may send a no failure indication to the computing device component.

In other embodiments, when the user-removably attached storage device receives a begin session command, a check may be automatically made to determine whether a previous begin session command was received with no intervening end session command. If a previous begin session command was received with no intervening end session command, then the user-removably attached storage device may send an abnormal session termination indication to the computing device.

After the computing device component receives an abnormal session termination indication from the user-removably attached storage device, the computing device component may send a query failure information command to the user-removably attached storage device. In response to receiving the query failure information command, the user-removably attached storage device may obtain detailed information regarding a failure, including, but not limited to, a component identifier, a session identifier, and a timestamp of a first begin session command and a second begin session command, having been received with no intervening end session command. The user-removably attached storage device may then send the detailed information to the computing device component. In other embodiments, additional or different information may be sent to the computing device component from the user-removably attached storage device, including but not limited to diagnostic information and specific failure codes.

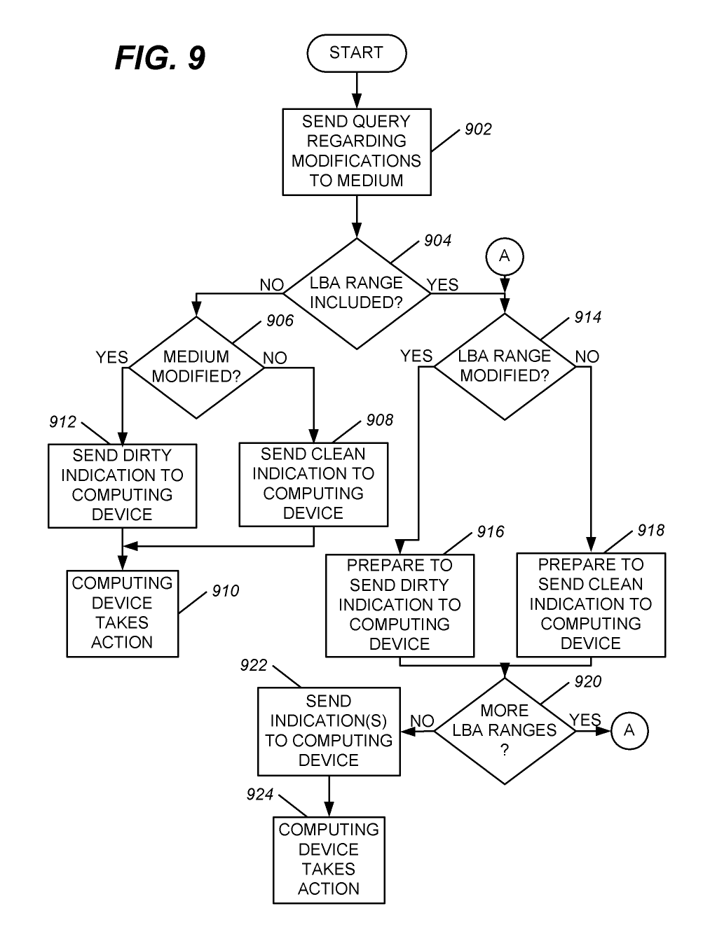

In various embodiments, a computing device component may send a command to a user-removably attached storage device to query modifications made to a medium of the user-removably attached storage device since a last end of session. FIG. 9 is a flowchart illustrating an exemplary procedure which may be performed by the computing device and the user-removably attached storage device with respect to a command to query whether modifications were made to the medium of the user-removably attached storage device since a last end of session.

The procedure may begin with the computing device sending a command, originated by the computing device component, to the user-removably attached storage device to query whether modifications were made to the medium of the user-removably attached storage device (act 902). The command may include a component identifier and one or more LBA ranges of the medium of the user-removably attached storage device. Upon receiving the command, the user-removably attached storage device may determine whether the one or more LBA ranges are included in the received command (act 904). If no LBA range is included in the received command, then the user-removably attached storage device may determine whether the medium was modified by any other computing device component of a same computing device or a different computing device (act 906). To determine whether the medium was modified, the user-removably attached storage device may reference recorded information regarding a last end of session associated with the component identifier and may determine whether any session associated with any other computing device component was established after the last end of session associated with the component identifier and/or the user-removably attached storage device may refer to information recorded in the medium indicating whether any other computing device component modified the medium of the user-removably attached storage device and if so, when the any other computing device component modified the medium of the user-removably attached storage device. The recorded information may include a component identifier, time information, and one or more LBA ranges. If the user-removably attached storage device determines that the medium may have been modified since a last end of session, then the user-removably attached storage device may send a dirty indication to the computing device component indicating that information recorded in the medium of the user-removably attached storage device may have been modified since the last end of session (act 912). Otherwise, the user-removably attached storage device may send a clean indication to the computing device component indicating that the information recorded in the medium of the user-removably attached storage device has not been modified since the last session ended (act 908). The computing device component of the computing device may then take a particular action depending on whether a dirty or a clean indication is received (act 910). For example, if a dirty indication is received, the computing device may present an error indication to a user of the computing device, or may take a different action. If a clean indication is received, the computing device may take an action such as, for example, trusting contents of the medium of the user-remote device, or may take a different action.

If, during act 904, the user-removably attached storage device determines that the received command includes one or more LBA ranges, then the user-removably attached storage device may determine whether an LBA range of the LBA ranges may have been modified (act 914). If the user-removably attached storage device determines that the LBA range may have been modified, then the user-removably attached storage device may prepare to send a dirty indication to the computing device component of the computing device indicating that information stored within the LBA range may have been modified after the last end of session (act 916). Otherwise, the user-removably attached storage device may prepare to send a clean indication to the computing device component indicating that the information recorded in the LBA range of the medium of the user-removably attached storage device has not been modified since the last end of session (act 918).

After performing either one of act 916 or act 918, the user-removably attached storage device may determine whether the received command includes an additional LBA range (act 920). If the user-removably attached storage device determines that the received command includes the additional LBA range, then the user-removably attached storage device may perform acts 914-920 regarding the additional LBA range. Otherwise, the user-removably attached storage device may send, to the computing device component of the computing device, respective clean and/or dirty indications for each of the one or more LBA ranges (act 922). The computing device may then take an appropriate action based on the received clean and/or dirty indications (act 924).

In some embodiments, a computing device may set and correct time information of the user-removably attached storage device. This may be accomplished by the computing device sending a set and correct time command to a user-removably attached storage device. The set and correct time command may include time information from the computing device. In one embodiment, the time information may be included in a timestamp included in the set and correct time command. Upon receiving the set and correct time command, the user-removably attached storage device may set and correct time information of the user-removably attached storage device according to the time information included in the set and correct time command. Upon successfully setting and correcting the time information, the user-removably attached storage device may send a success indication to the computing device. If the user-removably attached storage device is unable to successfully set and correct the time information, then the user-removably attached storage device may send a failure indication to the computing device.

In an embodiment that implements the set and correct time command, a computing device component may send the set and correct time command to a user-removably attached storage device only while a session is established between the computing device component and the user-removably attached storage device. In other embodiments, the computing device component may send the set and correct time command to the user-removably attached storage device at any time regardless of whether a session is established between the computing device component and a user-removably attached storage device.

### Exemplary Implementation

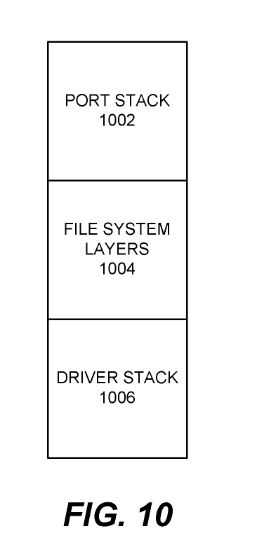

In one exemplary implementation on a computing device, a driver stack may encapsulate the embodiments described above with respect to the computing device. FIG. 10 illustrates exemplary layering with respect to a driver stack. As illustrated in FIG. 10, a driver stack 1006 may lie below file system layer 1004, which further lies below port stack 1002. When driver stack 1006 encapsulates the previously-described embodiments with respect to the computing device, file system layers 1004 and port stack 1002 may remain unaware of any changes made to drivers within driver stack 1006 to implement the previously-described embodiments.

In the one exemplary implementation, a driver within driver stack 1006 may discover whether a user-removably attached storage device is capable of supporting a session with the computing device. In one embodiment, the driver may send a particular command to the user-removably attached storage device and, in response, the driver may expect to receive a particular response from the user-removably attached storage device. When the particular response is received, the driver may then discover that the user-removably attached storage device supports a session with a computing device. Otherwise, the driver may discover that the user-removably attached storage device does not support a session with a computing device. In other embodiments, the driver may discover whether the user-removably attached storage device supports a session with a computing device via other methods.

When the driver discovers that the user-removably attached storage device is capable of supporting a session with the computing device, the driver may determine whether a storage medium of the user-removably attached storage device was modified since a last session between the computing device and the user-removably attached storage device ended. The driver may determine whether the storage medium was modified since the last session between a computing device and the user-removably attached storage device as described with respect to the flowchart of FIG. 9. For example, in act 902 (FIG. 9), the driver may send a query to the user-removably attached storage device regarding modifications to the storage medium. The query may include no LBA range with respect to the storage medium, or one or more LBA ranges. The user-removably attached storage device may determine whether any modification was made to any part of the storage medium (in the case of no LBA range in the query), or whether a modification was made to one or more LBA ranges of the storage medium (in the case of one or more LBA ranges in the query).

If the user-removably attached storage device determines that a modification was made, then a dirty indication may be sent to the driver from the user-removably attached storage device. Otherwise, the user-removably attached storage device may send a clean indication to be driver, as illustrated in FIG. 9. When the driver receives a clean indication from the user-removably attached storage device, the driver may trust contents of the storage medium. Otherwise, when the driver receives a dirty indication from the user-removably attached storage device, the driver may not trust contents of the storage medium.

Further, in the one exemplary implementation, the user-removably attached storage device may detect an abnormal session termination, as previously described, and may send an abnormal session termination indication to a driver within driver stack 1006. The driver may obtain detailed information regarding the abnormal session termination by sending a query failure command to the user-removably attached storage device in response to receiving the abnormal session termination indication.

In some embodiments, the driver may send a query abnormal session termination command to the user-removably attached storage device. In response to receiving the query abnormal session termination command, the user-removably attached storage device may send a response indicating whether or not an abnormal session termination was detected.

In addition, in the one exemplary implementation, one or more drivers of driver stack 1006 may generate a component identifier, query whether a component identifier is registered with a user-attached storage device, register a component identifier, and begin and end a session with the user-removably attached storage device as previously discussed.

### CONCLUSION

Various embodiments were described in which a user-removably attached storage device may become aware of an amount of time that has passed while the user-removably attached storage device was powered off. Further, in the various embodiments, a computing device component may query a user-removably attached storage device to determine whether another computing device component of a same computing device or a different computing device had access to the user-removably attached storage device and may have modified contents of a medium of the user-removably attached storage device. In addition, a computing device may benefit from discovering failure information from the user-removably attached storage device including, but not limited to, an abnormal session termination.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Other configurations of the described embodiments are part of the scope of this disclosure. For example, in other embodiments, an order of acts performed by a process may be different and/or may include additional or other acts.

Accordingly, the appended claims and their legal equivalents define embodiments, rather than any specific examples given.

We claim as our invention:

1. A method for managing a session between a component of a computing device and a storage device, the method comprising:
determining, by the storage device in response to receiving a query from the computing device, whether a modification to a medium of the storage device occurred since a last session between the component and the storage device, and
returning, by the storage device to the computing device, an indication regarding an occurrence of the modification to the medium of the storage device since the last session, when the modification to the medium of the storage device is determined to have occurred since the last session.

2. The method of claim 1, wherein:
the determining whether a modification to a medium of the storage device occurred since the last session between the component and the storage device further comprises:
determining, in response to receiving the query from the computing device, whether a modification to any address within a specific logical block address range of the medium of the storage device occurred since the last session between the component and the storage device; and
the returning an indication regarding an occurrence of the modification to the medium of the storage device since the last session further comprises:
returning the indication regarding the occurrence of the modification to the any address within the specific logical block address range of the medium of the storage device when the modification to the any address within the specific logical address range of the medium of the storage device is determined to have occurred since the last session between the component and the storage device.

3. The method of claim 1, further comprising:
determining, by the storage device, whether an abnormal termination of the last session between the component and the storage device occurred based on recorded session data; and
returning a second indication to the computing device regarding an occurrence of the abnormal termination of the last session between the component and the storage device, when the abnormal termination of the last session between the component and the storage is determined to have occurred.

4. The method of claim 1, further comprising:
setting and correcting time, by the storage device, in response to receiving a command from the computing device regarding setting and correcting the time.

5. The method of claim 1, further comprising:
receiving, by the storage device from the computing device, a begin session command including an identifier corresponding to the component of the computing device;
determining, by the storage device, whether the component is already in a session with the storage device; and
performing, when the determining determines that the component is not already in a session with the storage device:
recording, by the storage device, a beginning of a new session between the component of the storage device and the storage device, and
returning, to the computing device from the storage device, an indication of success of the request.

6. The method of claim 5, further comprising:
performing, when the determining determines that the component is already in a session with the storage device:
determining whether a session identifier included in the begin session command matches a recorded session identifier, and
performing when the session identifier included in the begin session command matches the recorded session identifier:
recording, by the storage device, and ending of the session, and
recording, by the storage device, a beginning of a new session between the component of the computing device and the storage device.

7. The method of claim 1, further comprising:
receiving, by the storage device, a register command from the computing device;
determining, by the storage device, whether a component identifier included in the received register command is already registered with the storage device;
performing, by the storage device, when the component identifier is determined to not be registered with the storage device:
registering, by the storage device, the component identifier, and
recording, by the storage device, a registration identifier included in the received register command.

8. The method of claim 7, wherein the registration identifier is based on time information from the component.

9. A storage device configured to be user-removably attached to a computing device, the storage device including instructions for a processor of the storage device to perform a method comprising:
receiving a register command including a component identifier from the computing device;
determining, in response to the receiving a register command, whether the component identifier is already registered with the storage device;
performing, when the component identifier is determined not to be registered with the storage device:
registering the component identifier with the storage device, the component identifier corresponding to a component of the computing device,
recording a registration identifier included in the registration command, and
providing an indication of a successful registration to the computing device; and
performing, when the component identifier is determined to be registered with the storage device:
determining whether the registration identifier included in the register command matches a previously recorded registration identifier, and
performing, when the registration identifier included in the register command is determined to match the previously recorded registration identifier:
providing an indication of a successful registration to the computing device.

10. The storage device of claim 9, wherein the method further comprises:
receiving a second command including a query with respect to at least one registered logical block address range of the storage device; and
responding, in response to the received query, with information indicative of the at least one registered logical block address range and with a creator signature used to register the at least one registered logical block address range.

11. The storage device of claim 9, wherein the method further comprises:
recording, in session data, time information with respect to an end of a session between the storage device and the computing device in response to receiving, from the component, an indication of an end of output activity with respect to the session; and
providing an indication of an abnormal session termination when the abnormal session termination is detected based on the recorded session data.

12. The storage device of claim 11, wherein the method further comprises:
detecting the abnormal session termination when the recorded session data indicates a beginning of a previous session between the component and the storage device followed by a beginning of a next session between the component and the storage device with no intervening recorded end of the previous session.

13. The storage device of claim 9, wherein:
the register command includes a logical block address range with respect to a medium of the storage device, and
the method further comprises:
determining whether a modification to any address within the logical block address range of the medium occurred since a last session between the component and the storage device, and
providing an indication that the modification to the any address within the logical block address range of the medium of the storage device occurred since the last session between the component and the storage device, as a result of determining that a modification to the any address within the logical block address range of the medium occurred.

14. The storage device of claim 9, wherein the method further comprises:
receiving a query from the computing device including a second identifier;
determining whether the second identifier is already registered with the storage device;
returning, to the computing device, an indication that the second identifier is already registered when the second identifier is determined to be registered with the storage device; and
returning, to the computing device, an indication that the second identifier is not registered when the second identifier is determined to not be registered with the storage device.

15. A computing device comprising:
at least one processor; and
a memory connected to the at least one processor, the memory including instructions for the at least one processor of the computing device to perform a method comprising:
choosing an identifier to correspond with a component of the computing device;
sending a first command to a storage device user-removably attached to the computing device to determine whether the identifier is already registered with the storage device, the first command including the identifier;
receiving a first indication from the storage device in response to the sending of the first command, the first indication indicating whether the identifier is registered with the storage device;
sending a second command to the storage device to register the identifier with respect to any modifications to a logical block address range of a medium of the storage device when the received first indication indicates that the identifier is not registered with the storage device;
sending a third command to the storage device to determine whether a modification to any address within the logical block address range of the medium of the storage device occurred since a last session between the component and the storage device;
receiving a response from the storage device in response to the sending of the third command, the response indicating that the modification to the any address of the logical block address range of the medium of the storage device occurred since the last session between the component and the storage device when the modification to the any address of the logical block address range is determined to have occurred since the last session; and
taking an action in response to the receiving the response from the storage device.

16. The computing device of claim 15, wherein the method further comprises:
performing, after the identifier is registered with the storage device:
sending a fourth command to the storage device to begin a session with the storage device, the fourth command including a session identifier, and
receiving, in response to the sending the fourth command, a second response from the storage device indicating either a success or a failure of beginning the session with the storage device.

17. The computing device of claim 16, wherein the session identifier includes a timestamp.

18. The computing device of claim 16, wherein the method further comprises:
sending a fifth command to the storage device to determine whether the last session terminated abnormally;
receiving, in response to the sending the fifth command, a third response from the storage device indicating either normal termination or abnormal termination of the last session; and
taking a second action in response to the third response indicating the abnormal termination of the last session.

19. The computing device of claim 15, wherein the method further comprises sending a fifth command to the storage device to cause the storage device to set and correct a time according to time information included in the fifth command.

20. The computing device of claim 15, wherein the method further comprises:
choosing a second identifier to correspond with a second component of the computing device;
sending a fifth command to the storage device to determine whether the second identifier is already registered with the storage device, the fifth command including the second identifier;
receiving a second indication from the storage device in response to the sending of the fifth command, the second indication indicating whether the second identifier is registered with the storage device; and
sending a sixth command to the storage device to register the second identifier with respect to any modifications to a second logical block address range of the medium of the storage device when the received second indication indicates that the identifier is not registered with the storage device.

21. A method for managing a session between a computing device and a user-removably attached storage device, the method comprising:
discovering, by a driver within a driver stack of the computing device, whether the user-removably attached storage device is capable of supporting a session with the computing device;
performing, when the driver determines that the user-removably attached storage device is capable of supporting a session with the computing device:
determining, by the driver, whether a storage medium of the user-removably attached storage device had been modified since a last end of a session between the computing device and the user-removably attached storage device, and
trusting, by the driver, contents of the storage medium of the user-removably attached storage device only when the driver determines that the storage medium had not been modified since the last end of session between the computing device and the storage device.

22. The method of claim 21, wherein: the method is encapsulated within the driver stack.

23. The method of claim 21, wherein:
the determining whether a storage medium of the user-removably attached storage device had been modified since a last end of a session between the computing device and the storage device further comprises
determining whether one or more logical block address ranges of the storage medium had been modified since the last end of session between the computing device and the storage device; and
the trusting contents of the storage medium of the storage device only when the driver determines that the storage medium had not been modified since the last end of session between the computing device and the storage device further comprises
trusting, by the driver, the contents of the one or more logical block address ranges of the storage medium of the storage device only when the driver determines that one or more logical block addresses of the storage medium had not been modified since the last end of session between the computing device and the storage device.

24. The method of claim 21, further comprising:
receiving, by a second driver of the driver stack, an abnormal session termination indication from the user-removably attached storage device;
sending, by the second driver, a query failure command to the user-removably attached storage device in response to the receiving of the abnormal session termination indication; and
receiving, by the second driver from the user-removably attached storage device, information in response to the sending of the query failure command.
